(19) United States
(12) Patent Application Publication
(10) Pub. No.: US 2023/0294378 A1
(43) Pub. Date: Sep. 21, 2023

(54) FLEXIBLE GEOMEMBRANE

(71) Applicant: KURARAY CO., LTD., Okayama (JP)

(72) Inventors: Edgard Chow, Houston, TX (US); Emilio Morales, Houston, TX (US); Makoto Okamoto, Zwijndrecht (BE)

(73) Assignee: KURARAY CO., LTD., Okayama (JP)

(21) Appl. No.: 18/122,980

(22) Filed: Mar. 17, 2023

Related U.S. Application Data
(60) Provisional application No. 63/321,191, filed on Mar. 18, 2022.

(51) Int. Cl. B32B 5/02; B32B 7/12; B32B 27/34; B32B 27/30; B32B 27/36; B32B 27/32; B32B 27/40; B32B 27/08; B32B 27/12

(52) U.S. Cl. CPC B32B 5/02; B32B 7/12; B32B 27/34; B32B 27/306; B32B 27/36; B32B 27/32; B32B 27/40; B32B 27/08; B32B 27/12; B32B 2307/714; B32B 2260/021; B32B 2260/046; B32B 2307/7244; B32B 2307/54; B32B 5/024; B32B 5/022; B32B 2262/0253; B32B 2262/0276; B32B 2262/0261; B32B 2262/0238; B32B 2262/065; B32B 2262/062

(57) ABSTRACT

A multilayer article including a chemical-resistant layer comprising a polyurea, where the chemical-resistant layer is not an adhesive layer between two layers, and a barrier layer comprising an ethylene-vinyl alcohol copolymer. The multilayer article has good flexibility and toughness, resistance to water and chemicals, and excellent barrier properties to organic solvents and gases.

### FIELD OF THE INVENTION

The present invention relates to a multilayer article including a chemical-resistant layer including a polyurea, where the chemical-resistant layer is not an adhesive layer between two layers, and a barrier layer including an ethylene-vinyl alcohol copolymer (“EVOH”). The multilayer article has both good flexibility and toughness and excellent barrier properties to organic solvents and gases. The multilayer article is used for the fabrication of liners and covers for the geotechnical industry (“geomembrane”).

### BACKGROUND OF THE INVENTION

Geomembranes are commonly used for the fabrication of liners and covers for the geotechnical industry, such as in refuse landfill, sewage and waste residue treatment plants, containment of residuals from oil and gas fields, and the like. Geomembrane materials are commonly homogeneous (made of one type of material), e.g. low-, medium- and high-density polyethylene (LDPE, MDPE, HDPE), polypropylene (PP), PVC, butyl rubber, chlorosulphonated polyethylene (CSPE/CPM), ethylene interpolymer alloy (EIA), or nitrile butadiene (NBR).

### SUMMARY OF THE INVENTION

Recently, there have been increased regulations on volatile organic compounds (VOC) and perfluoroalkyl substance, both of which pose a threat to soil, water and air quality. The contamination of organic solvents from waste to soil and underground water via diffusion through the geomembrane is a big potential risk. Gases from wastes are considered as risks for greenhouse effect, liability to human health and public odor complaints.

Polyurea is known for its toughness, flexibility, versatility, water resistance, and chemical resistance, and is often used in coating and/or geomembrane applications.

Ethylene-vinyl alcohol copolymer (“EVOH”) is known for its low permeation of gases and VOC relative to other commonly-used thermoplastic polymers, and has been considered for geomembrane applications. For geomembrane use, EVOH needs to be used as multilayer sheet co-extruded with HDPE and LLDPE; however, such a multilayer sheet is stiff and sometimes difficult to practically apply for select geotechnical applications that require high flexibility such as pond liners, floating covers and tubular biodigesters for animal waste ponds, liners and covers for food waste and other organic matter biodigesters, secondary containment liners, potable water reservoirs, canal liners for wastewater operations, daily landfill covers, etc.

EP2489509A1 discloses a flexible multi-layer ground membrane that comprises the polyamide layers, EVOH layers and polyolefin layers that are bonded together. The chemical resistance of a polyolefin geomembrane, which is non-polar in nature (and so prevents the passage of polar liquids such as methanol) can be significantly increased by incorporating layers of polar polymers. The converse is also valid, i.e. the chemical resistance of a polar material, e.g. a polyamide, can be significantly increased by incorporating layers of non-polar polymers. An EVOH layer also provides a highly effective diffusion barrier to polar liquids in the membrane.

The related art does not teach a practical EVOH-containing multilayer sheet that exhibits both good flexibility and excellent barrier resistance properties required for geomembrane applications, and does not suggest the use of a geomembrane made of a chemical-resistant layer including a polyurea, where the chemical-resistant layer is not an adhesive layer between two layers, and a barrier layer including an ethylene-vinyl alcohol copolymer.

When considering the combination of the chemical-resistant layer and the barrier layer as disclosed herein, the inventors discovered that when they tried to thermally press the chemical-resistant layer and barrier layer, no significant adhesion was achieved between both layers. Rather, they surprisingly found out that the adhesion could be achieved when the liquid polymer components for polyurea were mixed, allowed to react, and applied prior to curing onto a barrier layer containing a polyurea-compatible resin. It was believed that both polarity and surface energy of the polyurea-compatible resin directly contacting polyurea may contribute to good adhesion to the liquid polyurea in uncured or partially cured form. A practical application that may arise from this result is that the chemical-resistant layer may be directly adhered to the barrier layer without another adhesion layer between the two layers.

According to one aspect of the invention, a multilayer article may include a chemical-resistant layer comprising a polyurea, and a barrier layer comprising an ethylene-vinyl alcohol copolymer. In some embodiments, the chemical-resistant layer is not an adhesive layer between two layers. In some embodiments, the chemical-resistant layer may be an outermost layer of the multilayer article.

In some embodiments, the multilayer article may further include a thermoplastic resin layer. In some embodiments, the thermoplastic resin layer may include at least one resin selected from the group consisting of polyamide, ethylene-vinyl alcohol copolymer with an ethylene content of 70 mol % or less, polyethylene terephthalate, ethylene copolymer, polyurethane, acrylic copolymer, and methacrylate modified polyethylene. In some embodiments, the thermoplastic resin layer may include polyurethane or ethylene-vinyl alcohol copolymer with an ethylene content of 50 mol % or less.

In some embodiments, the multilayer article may further include a tie layer. In some embodiments, the tie layer may include an acid-functionalized polymer resin composition.

In some embodiments, the acid-functionalized polymer resin composition may include a carboxyl group-containing modified polyolefin resin obtained by chemically binding an unsaturated carboxylic acid to a polyolefin resin. In some embodiments, the acid-functionalized polymer resin composition may include a carboxyl group-containing modified polyolefin resin obtained by chemically binding an anhydride of an unsaturated carboxylic acid to a polyolefin resin. In some embodiments, the carboxyl group-containing modified polyolefin resin may include at least one of a polyethylene modified with maleic anhydride and a polypropylene modified with maleic anhydride. In some embodiments, the acid-functionalized polymer resin composition may include at least one of a polyethylene modified with maleic anhydride, a polypropylene modified with maleic anhydride, a maleic anhydride-modified ethylene-ethyl acrylate copolymer, and a maleic anhydride-graft-modified ethylene-vinyl acetate copolymer.

In some embodiments, the tie layer may be directly adhered to both of the thermoplastic resin layer and the barrier layer.

In some embodiments, the chemical-resistant layer may consist of polyurea.

In some embodiments, the multilayer article may further include a thermoplastic resin layer, wherein the thermoplastic resin layer is between the chemical-resistant layer and the barrier layer.

In some embodiments, the thermoplastic resin layer may be directly adhered to the chemical-resistant layer. In some embodiments, the chemical-resistant layer and the barrier layer may be directly adhered to each other.

In some embodiments, the multilayer article may further include an adhesive layer comprising polyurea, and a geotextile layer comprising a polyurea-impregnated geotextile between the chemical-resistant layer and the adhesive layer. In some embodiments, the adhesive layer may be located between the geotextile layer and the barrier layer.

In some embodiments, said geotextile layer may be directly adhered to the chemical-resistant layer and the adhesive layer.

In some embodiments, the adhesive layer may be directly adhered to the barrier layer. In some embodiments, the multilayer article may further include a thermoplastic resin layer, wherein the thermoplastic resin layer is between the adhesive layer and the barrier layer.

In some embodiments, the thermoplastic resin layer may be directly adhered to the adhesive layer.

In some embodiments, the chemical-resistant layer may include a polyurea-impregnated geotextile. In some embodiments, the multilayer article may further include an adhesive layer comprising polyurea between the chemical-resistant layer and the barrier layer. In some embodiments, said adhesive layer may be directly adhered to the chemical-resistant layer. In some embodiments, said adhesive layer may be directly adhered to the barrier layer. In some embodiments, the multilayer article may further include a thermoplastic resin layer, wherein the thermoplastic resin layer is between the adhesive layer and the barrier layer. In some embodiments, the thermoplastic resin layer may be directly adhered to the adhesive layer.

In some embodiments, the multilayer article may further include another thermoplastic resin layer. In some embodiments, said another thermoplastic resin layer may not be located between the barrier layer and the chemical-resistant layer. In some embodiments, said another thermoplastic resin layer may be an outermost layer of the multilayer article. In some embodiments, the thermoplastic resin layer may include at least one resin selected from the group consisting of polyamide, ethylene-vinyl alcohol copolymer with an ethylene content of 70 mol % or less, polyethylene terephthalate, ethylene copolymer, polyurethane, acrylic copolymer, and methacrylate modified polyethylene. In some embodiments, the thermoplastic resin layer may include at least one selected from the group consisting of polyurethane or ethylene-vinyl alcohol copolymer with an ethylene content of 50 mol % or less.

In some embodiments, each of the chemical-resistant layer, the adhesive layer, and the geotextile layer may not be adhered to a layer comprising at least one of polyethylene, polypropylene, vinyl acetate, ethylene-vinyl acetate, and polyolefin.

According to another aspect of the invention, an article may include: (i) the multilayer article described herein, (ii) another multilayer article that may include another chemical-resistant layer that may include a polyurea, wherein said another chemical-resistant layer may not be an adhesive layer between two layers, and another barrier layer that may include an ethylene-vinyl alcohol copolymer, and (iii) a seam layer between the multilayer article and said another multilayer article. In some embodiments, the seam layer may include polyurea. In some embodiments, the seam layer may be directly adhered to layers, each of which may independently include at least one resin selected from the group consisting of polyamide, ethylene-vinyl alcohol copolymer with an ethylene content of 70 mol % or less, polyethylene terephthalate, ethylene copolymer, polyurethane, acrylic copolymer, and methacrylate modified polyethylene. In some embodiments, the seam layer may be directly adhered to layers, each of which may independently include at least one selected from the group consisting of polyurethane or ethylene-vinyl alcohol copolymer with an ethylene content of 50 mol % or less. In some embodiments, the seaming layer may include a foam body.

In some embodiments, the article may include a structure:

PU1/X1/(T1/X2/T2)n/X3/PU2/X4/(T3/X5/T4)n/X6/PU3

Wherein PU1 may be a first polyurea-impregnated geotextile layer; PU2 may be the seam layer comprising polyurea; PU3 may be a second polyurea-impregnated geotextile layer; each of X1, X2, X3, X4, X5 and X6 may be independently a thermoplastic resin layer or a barrier layer, wherein at least one may be a barrier layer; each of X1, X3, X4 and X6 may independently include at least one resin selected from the group consisting of polyamide, ethylene-vinyl alcohol copolymer, polyethylene terephthalate, ethylene copolymer with an ethylene content of 70 mol % or less, polyurethane, acrylic copolymer, and methacrylate modified polyethylene; each of T1, T2, T3 and T4 may independently include a tie resin composition; and n may be a whole number from 1 to 12. In some embodiments, each of X1, X3, X4 and X6 may independently include at least one selected from the group consisting of polyurethane or ethylene-vinyl alcohol copolymer with an ethylene content of 50 mol % or less.

In some embodiments, the multilayer article described herein may be a geomembrane. In some embodiments, the multilayer article may be used for environmental protection of air, soil, and/or water. In some embodiments, the multilayer article may be used for maintaining the quality of air, soil, and/or water. In some embodiments, the multilayer article may be used for protecting the quality of air, soil, and/or water. In some embodiments, the multilayer article may be used as a liner for secondary containment of chemicals in a tank farm and/or a chemical processing unit. In some embodiments, the multilayer article be used as a liner for capping of a brownfield site. In some embodiments, the multilayer article be used as a liner for a under-slab vapor intrusion membrane. In some embodiments, the multilayer article be used as a liner or a cover for a geotechnical application. In some embodiments, the geotechnical application may include at least one of refuse landfill, sewage and/or waste residue treatment plants, and containment of residuals from oil and/or gas fields.

In some embodiments, the present disclosure relates to use of the multilayer article for environmental protection of air, soil, and/or water. In some embodiments, use of the multilayer article for maintaining the quality of air, soil, and/or water. In some embodiments, the present disclosure relates to use of the multilayer article for protecting the quality of air, soil, and/or water. In some embodiments, the present disclosure relates to use of the multilayer article for a liner for secondary containment of chemicals in a tank farm and/or a chemical processing unit. In some embodiments, the present disclosure relates to use of the multilayer article for a liner for capping of a brownfield site. In some embodiments, the present disclosure relates to use of the multilayer article for a liner for an under-slab vapor intrusion membrane. In some embodiments, the present disclosure relates to use of the multilayer article for a liner or a cover for a geotechnical application. In some embodiments, the geotechnical application may include at least one of refuse landfill, sewage and/or waste residue treatment plants, and containment of residuals from oil and/or gas fields.

In some embodiments, the multilayer article may exclude a citric acid-modified polyvinyl amine layer.

According to another aspect of the invention, in a process for preparing the multilayer article or the article, the process may include applying the chemical-resistant layer to the barrier layer. In some embodiments, the application of the chemical-resistant layer may include mixing precursors of the polyurea to form the polyurea and applying the resulting mixture to the barrier layer. In some embodiments, the application of the chemical resistant layer may exclude thermally pressing the chemical-resistant layer and the barrier layer.

According to the aspects of the present invention, a multilayer sheet is provided that is superior in flexibility, toughness, water resistance and chemical resistance, has excellent organic solvent barrier and is also suitable for long-term geomembrane use.

These and other embodiments, features and advantages of the present invention will be more readily understood by those of ordinary skill in the art from a reading of the following detailed description.

### BRIEF DESCRIPTION OF THE DRAWINGS

FIG. 1 is a schematic diagram of an embodiment of an article in accordance with the present invention.

FIG. 2 is a photograph of crumbled polyurea after a thermal press.

FIG. 3 shows photographs of polyurea (yellow) adhering to specific polyurea-compatible resins.

### DETAILED DESCRIPTION

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a mass or weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

The present invention relates to a multilayer article including a chemical-resistant layer including a polyurea, where the chemical-resistant layer is not an adhesive layer between two layers, and a barrier layer including an ethylene-vinyl alcohol copolymer (“EVOH”). The multilayer article has both good flexibility and toughness and excellent barrier properties to organic solvents and gases. The multilayer article is used for the fabrication of liners and covers for the geotechnical industry (“geomembrane”). Further details are provided below.

### Chemical-Resistant Layer

In one aspect, the multilayer articles of the present disclosure may include a chemical-resistant layer including a polyurea. The thickness of the chemical-resistant layer may not be particularly limited, and may be typically about 50, 100, 150, 200, 300, 400, 600, 800, 1000, 1200, 1400, 1600, 1800, 2000, 2200, or 2400 μm or thicker, and/or about 100, 150, 200, 300, 400, 600, 800, 1000, 1200, 1400, 1600, 1800, 2000, 2200, 2400, 2600, 2800, 3000 μm or thinner. For example, the thickness may be from about 50 μm to 3000 μm. In some embodiments, the chemical-resistant layer is not an adhesive layer between two layers.

The term “polyurea,” as used herein, may refer to neat polyurea polymer, to copolymers formed from precursors of polyurea and other comonomers, or to compositions comprising polyurea polymer and at least one additional material. The polyurea may be flexible, durable, and resistant to chemicals and moisture and may impart the same or similar properties to the chemical-resistant layer.

Polyurea is formed by reacting an isocyanate with an amine. The ratio of equivalents of isocyanate groups to equivalents of amine groups may be greater than 1, for example, about 1.01, 1.02, 1.03, 1.04, 1.05, 1.06, 1.07, 1.08, 1.09, 1.11, 1.12, 1.13, 1.14, 1.15, 1.16, 1.17, 1.18, 1.19, 1.20, 1.21, 1.22, 1.23, 1.24, or 1.25 or more. The ratio may be 1.05, 1.06, 1.07, 1.08, 1.09, 1.11, 1.12, 1.13, 1.14, 1.15, 1.16, 1.17, 1.18, 1.19, 1.20, 1.21, 1.22, 1.23, 1.24, or 1.25 or less.

As used herein, the term “isocyanate” includes unblocked compounds capable of forming a covalent bond with a reactive group such as a hydroxyl or amine functional group. The isocyanate may be monomeric containing one isocyanate functional group (NCO) or may be polymeric containing two or more isocyanate functional groups (NCOs). In some embodiments, the isocyanate may include diisocyanates having the generic structure O═C═N—R—N═C═O, where R is a cyclic, aromatic, or linear or branched hydrocarbon moiety containing from about 1 to about 50 carbon atoms. R may contain about 1, 2, 3, 4, 5, 6, 7, 8, 9, 10, 11, 12, 13, 14, 15, 16, 17, 18, 19, 20, 22, 24, 26, 28, 30, 35, 40, or 45 carbon atoms or more. R may contain about 3, 4, 5, 6, 7, 8, 9, 10, 11, 12, 13, 14, 15, 16, 17, 18, 19, 20, 22, 24, 26, 28, 30, 35, 40, 45, or 50 carbon atoms or less.

In some embodiments, the isocyanate may be represented by the general formula, R—(N═C═O)x, where R can be any organic radical having a valence x (e.g., x may be 3 or 4) and may include the R groups mentioned above. R may be a straight or branched hydrocarbon moiety, acyclic group, cyclic group, heterocyclic group, aromatic group, phenyl group, hydrocarbylene group, or a mixture thereof. For example, R may be a hydrocarbylene group having about 6 to about 25 carbons. R may contain about 6, 7, 8, 9, 10, 11, 12, 13, 14, 15, 16, 17, 18, 19, 20, 22, or 24 carbon atoms or more. R may contain about 7, 8, 9, 10, 11, 12, 13, 14, 15, 16, 17, 18, 19, 20, 22, 24, or 25 carbon atoms or less. In some embodiments, R may be unsubstituted or substituted. For example, the cyclic or aromatic group(s) may be substituted at the 2-, 3-, and/or 4-positions, or at the ortho-, meta-, and/or para-positions, respectively. Substituted groups include, but are not limited to, halogens, primary, secondary, or tertiary hydrocarbon groups, or a mixture thereof.

Isocyanates for use in the present disclosure are numerous and may vary widely. Such isocyanates can include those that are known in the art. Examples of suitable isocyanates may include monomeric and/or polymeric isocyanates. The polyisocyanates may include monomers, prepolymers, oligomers, or blends thereof. For example, the polyisocyanate may be C2-C20 linear, branched, cyclic, aromatic, or any blend thereof.

Isocyanates that can be employed in the present disclosure may include 3,3,5-trimethyl-5-isocyanato-methyl-cyclohexyl isocyanate, also referred to as isophorone diisocyanate (IPDI); hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; substituted and isomeric mixtures including 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; car-bodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylene diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclo-hexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatomethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclohexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diiso-cyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, triphenylmethane 4,4′,4″-triisocyanate, isocyanatoethyl methacrylate, 3-isopropenyl-α,α-dimethylbenzyl-isocyanate, dichlorohexamethylene diisocyanate, ω,ω′-diisocyanato-1,4-diethylbenzene, polymethylene polyphenylene polyisocyanate, isocyanurate modified compounds, and carbodiimide modified compounds, as well as biuret modified compounds of the above polyisocyanates. These isocyanates may be used either alone or in combination. These combination isocyanates include triisocyanates, such as biuret of hexamethylene diisocyanate and triphenylmethane triisocyanates, and polyisocyanates, such as polymeric diphenylmethane diisocyanate, triisocyanate of HDI; triisocyanate of 2,2,4-trimethyl-1,6-hexane diisocyanate (TMDI); 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, and mixtures thereof, dimerized uretdione of any polyisocyanate, such as uretdione of toluene diisocyanate, uretdione of hexamethylene diisocyanate, and mixtures thereof; modified polyisocyanate derived from the above isocyanates and polyisocyanates; and mixtures thereof.

Aromatic isocyanates may include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate; and mixtures thereof.

In some embodiments, polyisocyanate monomer may be employed. For example, the isocyanate component may include at least 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, 3.0, 3.2, 3.4, 3.6, 3.8, 4.0, 4.5, 5.0, 5.5, 6.0, 7.0, 8.0, 9.0, or 10 wt % of at least one polyisocyanate monomer, based on a total weight of the isocyanate component. The isocyanate component may include not more than 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, 3.0, 3.2, 3.4, 3.6, 3.8, 4.0, 4.5, 5.0, 5.5, 6.0, 7.0, 8.0, 9.0, 10.0, 15.0, 20.0, 30.0, 40.0, 50.0, or 60.0 wt % of at least one polyisocyanate monomer, based on a total weight of the isocyanate component. Additionally, the isocyanate component may include oligomeric polyisocyanate, such as dimers, trimers, and polymeric oligomers, and modified polyisocyanates, such as carbodiimides and uretone-imines, and mixtures thereof.

Amines may be selected from a wide variety of known amines such as primary and secondary amines, and mixtures thereof. In some embodiments, the amine may include monoamines, or polyamines having at least two functional groups such as di-, tri-, or higher functional amines; and mixtures thereof. In some embodiments, the amine may be aromatic or aliphatic such as cycloaliphatic, or mixtures thereof. Suitable amines may include aliphatic polyamines such as ethylamine, isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-L5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

Secondary amines may include mono- and poly-acrylate and methacrylate modified amines; aliphatic polyamines and the like; and mixtures thereof.

In some embodiments, the amine can include an amine-functional resin. Suitable amine-functional resins may be selected from a wide variety known in the art and can include those having relatively low viscosity. For example, the amine-functional resin can be an ester of an organic acid, such as, an aspartic ester-based amine-functional reactive resin that is compatible with isocyanate. In some embodiments, the isocyanate can be solvent-free, and/or has a mole ratio of amine-functionality to the ester of no more than 1:1 so that no excess primary amine remains upon reaction.

In some embodiments, the amine may include high molecular weight primary amine, such as polyoxyalkyleneamine. Suitable polyoxyalkyleneamines may contain two or more primary amino groups attached to a backbone derived, for example, from propylene oxide, ethylene oxide, or mixtures thereof.

In some embodiments, the amine for use in the present disclosure may include the reaction product of primary amine with monoepoxide to produce secondary amine and reactive hydroxyl group.

In some embodiments, the amine component may be a mixture of primary and secondary amines wherein the primary amine may be present in an amount of about 20, 21, 22, 23, 24, 25, 26, 27, 28, 29, 30, 32, 34, 36, 38, 40, 42, 44, 46, 48, 50, 55, 60, 65, 70, or 75 wt % or more and/or 22, 23, 24, 25, 26, 27, 28, 29, 30, 32, 34, 36, 38, 40, 42, 44, 46, 48, 50, 55, 60, 65, 70, 75, or 80 wt % or less, based on a total weight of the amine component, with the balance being secondary amine. For example, the primary amine may be present in an amount of from about 20 to 80 wt % or from 20 to 50 wt %. In some embodiments, the primary amines may have a molecular weight greater than 200, 210, 220, 230, 240, 250, 260, 270, 280, 290, 300, 320, 340, or 360, and/or less than 220, 230, 240, 250, 260, 270, 280, 290, 300, 320, 340, 360, 380, or 400, and the secondary amines may include diamine having molecular weight of at least 190, 200, 210, 220, 230, 240, 250, 260, 270, 280, 290, 300, 320, 340, or 360, and/or less than 220, 230, 240, 250, 260, 270, 280, 290, 300, 320, 340, 360, 380, or 400, or from 210 to 230.

In some embodiments, a primary amine may not be present in the amine component. In some embodiments, the amine component may include at least one secondary amine which is present in an amount of from 20 to 80 wt % or 50 to 80 wt % based on a total weight of the amine component. For example, the secondary amine may be present in an amount of about 20, 21, 22, 23, 24, 25, 26, 27, 28, 29, 30, 32, 34, 36, 38, 40, 42, 44, 46, 48, 50, 55, 60, 65, 70, or 75 wt % or more and/or 22, 23, 24, 25, 26, 27, 28, 29, 30, 32, 34, 36, 38, 40, 42, 44, 46, 48, 50, 55, 60, 65, 70, 75, or 80 wt % or less, based on a total weight of the amine component.

In some embodiments, the amine component may include aliphatic amine to enhance durability. Such amine may typically be provided as a liquid having a relatively low viscosity, for example, less than about 100, 90, 80, 70, or 60 mPas at 25° C.

Polyurea may be pre-formulated as two-component liquid formulations. A first component may include polyisocyanates such as a crosslinking prepolymer based on MDI (methylene diphenylisocyanate). In some embodiments, the first component may include at least 50, 51, 52, 53, 54, 55, 56, 57, 58, 59, 60 wt % and/or 65, 64, 63, 62, 61, 60, 59, 58, 57, or 56% wt % or less of a MDI or MDI prepolymer based on a total weight of the first component. In some embodiments, the first component may include at least 7, 8, 9, 10, 12, 13, 14 or 15 wt % and/or 31, 30, 29, 28, 27, 26, 25, 24, 23, 22, 21, 20, 19, 18, 17, 16 or 15 wt % or less of 4,4′-diphenylmethane diisocyanate based on a total weight of the first component. In some embodiments, the first component may include 50-65 wt % of a MDI prepolymer, 10-20 wt % of 4,4′-diphenylmethane diisocyanate, 10-20 wt % of diphenylmethane diisocyanate mixed isomers, and 10% or less of 4-methyl-1,3-dioxolan-2-one, based on a total weight of the first component. In some embodiments, the first component may include 36-60 wt % of polyglycol 15, a polymer of glycerin and ethylene oxide, based on a total weight of the first component. For example, the first component may include at least 30, 31, 32, 33, 34, 35, 36, 37, 38, 39, 40, 41, 42, 43, 44, 45, 46, 47, 48, 49, 50, 52, 54, or 56 wt % of polyglycol 15 and/or not more than 37, 38, 39, 40, 41, 42, 43, 44, 45, 46, 47, 48, 49, 50, 52, 54, 56, 58, or 60 wt % of polyglycol 15, based on a total weight of the first component. In some embodiments, the first component may include 24-41 wt % of MDI. In some embodiments, the first component may include 7.8-31 wt % of 4,4′-diphenylmethane diisocyanate based on a total weight of the first component. Examples of the first component may include TCS 380-CL A manufactured by MatLor, LLC and TCS HM, A-Side manufactured by MatLor, LLC. The term “prepolymer,” as used herein, refers to polyisocyanate which is pre-reacted with polyamine or other isocyanate reactive group such as polyol. Suitable polyisocyanates may include those disclosed herein. Suitable polyamines are numerous and may be selected from a wide variety known in the art. Suitable polyamines may include primary, secondary and tertiary amines, and mixtures thereof. Further examples may include those disclosed herein. Likewise, suitable polyols are numerous and may be selected from a wide variety known in the art. Polyols may include polyether polyols, polyester polyols, polycaprolactone polyols, polycarbonate polyols, polyurethane polyols, poly vinyl alcohols, polymers containing hydroxy functional acrylates, polymers containing hydroxy functional methacrylates, polymers containing allyl alcohols and mixtures thereof.

A second component may include a low molecular plasticized solution and a resin blend, which may include at least one amine-terminated polymer resin, optionally at least one amine-terminated chain extender, and optionally hydroxyl-terminated polymer resins as, for example, impurities. In some embodiments, the second component may include, based on a total weight of the second component, 40-60 wt % of polyoxypropylenediamine, or at least 40, 41, 42, 43, 44, 45, 46, 47, 48, 49, 50, 51, 52, 53, 54, 55, 56, 57, 58, or 59 wt % of polyoxypropylenediamine, and/or not more than 41, 42, 43, 44, 45, 46, 47, 48, 49, 50, 51, 52, 53, 54, 55, 56, 57, 58, 59, or 60 wt % of polyoxypropylenediamine. In some embodiments, the second component may include, based on a total weight of the second component, 10-20 wt % of diethylmethylbenzenediamine, or at least 10, 11, 12, 13, 14, 15, 16, 17, 18, or 19 wt % of diethylmethylbenzenediamine, and/or not more than 11, 12, 13, 14, 15, 16, 17, 18, 19, or 20 wt % of diethylmethylbenzenediamine. In some embodiments, the second component may include, based on a total weight of the second component, 10-20 wt % of glyceryl poly(oxypropylene) triamine, or at least 10, 11, 12, 13, 14, 15, 16, 17, 18, or 19 wt % of glyceryl poly(oxypropylene) triamine, and/or not more than 11, 12, 13, 14, 15, 16, 17, 18, 19, or 20 wt % of glyceryl poly(oxypropylene) triamine. In some embodiments, the second component may include, based on a total weight of the second component, 10-15 wt % of N,N′-dialkylamino-diphenylmethane, or at least 10, 11, 12, 13, or 14 wt % of N,N′-dialkylamino-diphenylmethane, and/or not more than 11, 12, 13, 14, or 15 wt % of N,N′-dialkylamino-diphenylmethane. In some embodiments, the second component may include, based on a total weight of the second component, 27-45 wt % of 4,4′-methylenebis[N-(1-methylpropyl)-benzenamine, or at least 27, 28, 29, 30, 31, 32, 33, 34, 35, 36, 37, 38, 39, 40, 41, 42, 43, or 44 wt % of 4,4′-methylenebis[N-(1-methylpropyl)-benzenamine, and/or not more than 28, 29, 30, 31, 32, 33, 34, 35, 36, 37, 38, 39, 40, 41, 42, 43, 44, or 45 wt % of 4,4′-methylenebis[N-(1-methylpropyl)-benzenamine. In some embodiments, the second component may include, based on a total weight of the second component, 18.5-31 wt % of N,N′-(methylenedi-4,1-cyclohexanediyl)bis-1,1′,4,4′-tetraethyl aspartic acid ester, or at least 18.5, 19, 20, 21, 22, 23, 24, 25, 26, 27, 28, 29, or 30 wt % of N,N′-(methylenedi-4,1-cyclohexanediyl)bis-1,1′,4,4′-tetraethyl aspartic acid ester, and/or not more than 19, 20, 21, 22, 23, 24, 25, 26, 27, 28, 29, 30, or 31 wt % of N,N′-(methylenedi-4,1-cyclohexanediyl)bis-1,1′,4,4′-tetraethyl aspartic acid ester. In some embodiments, the second component may include, based on a total weight of the second component, 17.2-29 wt % of poly(propyleneglycol)diamine, or at least 17.2, 18, 19, 20, 21, 22, 23, 24, 25, 26, 27, or 28 wt % of poly(propyleneglycol)diamine, and/or not more than 18, 19, 20, 21, 22, 23, 24, 25, 26, 27, 28, or 29 wt % of poly(propyleneglycol)diamine. In some embodiments, the second component may include, based on a total weight of the second component, 6-24 wt % of a cyclic propylene ester of carbonic acid, or at least 6, 7, 8, 9, 10, 11, 12, 13, 14, 15, 16, 17, 18, 20, or 22 wt % of a cyclic propylene ester of carbonic acid, and/or not more than 7, 8, 9, 10, 11, 12, 13, 14, 15, 16, 17, 18, 20, 22, or 24 wt % of a cyclic propylene ester of carbonic acid. In some embodiments, the second component may include, based on a total weight of the second component, 0.12-2.2 wt % of an aliphatic carboxylic ester, or at least 0.12, 0.2, 0.3, 0.4, 0.5, 0.6, 0.7, 0.8, 0.9, 1.0, 1.1, 1.2, 1.3, 1.4, 1.5, 1.6, 1.7, 1.8, 2.0, or 2.1 wt % of an aliphatic carboxylic ester, and/or not more than 0.3, 0.4, 0.5, 0.6, 0.7, 0.8, 0.9, 1.0, 1.1, 1.2, 1.3, 1.4, 1.5, 1.6, 1.7, 1.8, 2.0, or 2.2 wt % of an aliphatic carboxylic ester. In some embodiments, the second component may include, based on a total weight of the second component, 0.02-0.29% of odorless mineral spirits, or at least 0.02, 0.03, 0.04, 0.05, 0.06, 0.07, 0.08, 0.09, 0.10, 0.12, 0.14, 0.16, 0.18, 0.20, 0.22, 0.24, or 0.26 wt % of odorless mineral spirits, and/or not more than 0.02, 0.03, 0.04, 0.05, 0.06, 0.07, 0.08, 0.09, 0.10, 0.12, 0.14, 0.16, 0.18, 0.20, 0.22, 0.24, 0.26, or 0.29 wt % of an aliphatic carboxylic ester. Examples of the second component may include TCS 380-CL B manufactured by MatLor, LLC and TCS HM, B-Side manufactured by MatLor, LLC.

As understood in the art, the ratio of equivalents of isocyanate groups to amine groups may be selected to control the rate of cure of the polyurea. For example, when applying the polyurea in a 1:1 volume ratio of the first and second components, the ratio of the equivalents of isocyanate groups to amine groups (also known as the reaction index) may be greater than 1, such as from 1.01, 1.02, 1.03, 1.04, 1.05, 1.06, 1.07, 1.08, 1.09, 1.10, 1.11, 1.12, or 1.13 to 1.15:1, or from 1.01, 1.02, 1.03, 1.04, 1.05, 1.06, 1.07, or 1.08 to 1.10:1, or from 1.05 or 1.06 to 1.08:1. The ratio may be not more than 1.15, 1.14, 1.13, 1.12, 1.11, 1.10, 1.09, 1.08, 1.07, 1.06, 1.05, 1.04, 1.03, or 1.02. The term “1:1 volume ratio” means that the volume ratio may vary by up to 20, 19, 18, 17, 16, 15, 14, 13, 12, or 11% for each component, or up to 10, 9, 8, 7, or 6%, or up to 5, 4, 3, 2, 1 or 0%.

Polyurea compositions suitable for use in the present disclosure are generally known, for example, as otherwise currently used in coatings and/or geomembrane applications, as will be recognized by one of ordinary skill in the relevant art. In some embodiments, polyurea compositions may include processing aids, plasticizers, stabilizers (e.g., UV stabilizers and/or heat stabilizers), and possibly other additives (e.g., pigments or fillers, lubricants, and/or antioxidants). The amount of polyurea in such compositions may be less than 100%.

In some embodiments, the polyurea composition may include low or high molecular weight plasticizers, for example, one or more phthalate plasticizers such as a branched or unbranched alkyl phthalates like diethyl hexyl phthalate (DEHP), diisononyl phthalate, phthalates of C₇-C₁₁ linear alcohols or mixtures thereof, and diisodecyl phthalate. In some embodiments, the polyurea composition may include an additional polymer or copolymer, such as a polyvinyl acetate, polyvinyl butyral or polyvinyl alcohol, whose function is to provide further flexibility or to improve impact strength. In some embodiments, the polyurea composition may include a UV stabilizer and/or a heat stabilizer, which may contain barium, zinc, tin and/or calcium, such as a zinc organometallic soap optionally combined with costabilizers such as epoxidized soybean oil. The heat stabilizer may be an octyltin thioglycolate/dioctyltin thioglycolate mixture. In some embodiments, the polyurea composition may include pigments such as inorganic and/or organic colorants.

The pot life of the polyurea composition may be 8-9 minutes (e.g., at least about 8.0, 8.1, 8.2, 8.3, 8.4, 8.5, 8.6, 8.7, or 8.8 minutes and not more than 8.2, 8.3, 8.4, 8.5, 8.6, 8.7, 8.8, 8.9, or 9.0 minutes) at about 24° C. or about 10-12 minutes (e.g., at least about 10.0, 10.1, 10.2, 10.3, 10.4, 10.5, 10.6, 10.7, 10.8, 10.9, 11, 11.2, 11.4, 11.6, or 11.8 minutes and not more than 10.1, 10.2, 10.3, 10.4, 10.5, 10.6, 10.7, 10.8, 10.9, 11, 11.2, 11.4, 11.6, 11.8, or 12 minutes) at about 7° C.

In another aspect, the multilayer article of the present disclosure may have the chemical-resistant layer as an outermost layer of the multilayer article.

In another aspect, the multilayer article of the present disclosure may have a chemical-resistant layer that may consist of polyurea. In some embodiments, the chemical-resistant layer may consist of the neat polyurea polymer and/or copolymers formed from precursors of polyurea and other comonomers.

In some embodiments, the chemical-resistant layer has a thickness from 125 to 300 μm. In some embodiments, the thickness may be about 125, 135, 145, 155, 155, 165, 175, 185, 195, 205, 215, 225, 235, 245, 255, 265, 275, 285, or 295 μm or more. In some embodiments, the thickness may be about 145, 155, 155, 165, 175, 185, 195, 205, 215, 225, 235, 245, 255, 265, 275, 285, 295, or 300 μm or less.

### Barrier Layer

In another aspect, the multilayer article of the present disclosure may include a barrier layer including an ethylene-vinyl alcohol copolymer (“EVOH”). The thickness of the barrier layer may not be particularly limited, and may be typically at least about 50, 100, 150, 200, 300, 400, 500, 600, 700, 800, or 900 μm, and/or not more than 100, 150, 200, 300, 400, 500, 600, 700, 800, 900, or 1000 μm. In some embodiments, the EVOH may be a copolymer having a main structural unit including an ethylene unit and a vinyl alcohol unit.

The EVOH may desirably have, as a lower limit of ethylene unit content (a proportion of the number of ethylene units to the total number of monomer units in the EVOH), an ethylene unit content of about 20, 21, 22, 23, 24, 25, 26, 27, 28, 29, 30, 31, 32, 33, 34, 35, 36, 37, 38, 39, 40, 41, 42, 43, 44, 45, 46, or 47 mol % or greater. On the other hand, the EVOH may desirably have, as an upper limit of ethylene unit content, an ethylene unit content of about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54 or 55% or less mol % or less. In some embodiments, 20-50%, or 24-48%. In some embodiments, 27, 32, 35, 38, 44 or 48%. The EVOH having an ethylene unit content of no less than the lower limit may form a crosslinked product having excellent melt moldability and excellent oxygen barrier properties in high humidity. In addition, the EVOH having an ethylene unit content of no greater than the upper limit may impart excellent oxygen barrier properties.

The EVOH may typically have, as a lower limit of degree of saponification (a proportion of the number of vinyl alcohol units to the total number of the vinyl alcohol units and vinyl ester units in the EVOH), a degree of saponification of at least about 80, 81, 82, 83, 84, 85, 86, 87, 88, 89, 90, 91, 92, 93, 94, 95, 96, 97, 98, or 99 mol %. On the other hand, the EVOH may typically have, as an upper limit of degree of saponification, a degree of saponification of (substantially) 100 mol %, or about 99.99, 99.5, 99.0, 98, 97, 96, 95, 94, 93, 92, 91, 90, 89, 88, 87, 86, 85, 84, 83, or 82 mol % or less. The EVOH having a degree of saponification of no less than the lower limit may impart excellent oxygen barrier properties and thermal stability.

A method of preparing the ethylene-vinyl alcohol copolymer may not be particularly limited, and may include well-known preparing methods. For example, in a general method, an ethylene-vinyl ester copolymer obtained by copolymerizing ethylene and vinyl ester monomer may be saponified under the presence of a saponification catalyst, in an organic solvent including alcohol.

Examples of the vinyl ester monomer may include vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, and vinyl benzoate. Particularly, vinyl acetate is preferable.

A method of copolymerizing ethylene and vinyl ester monomer may include well-known methods such as solution polymerization, bulk polymerization, suspension polymerization, and emulsion polymerization. As a polymerization initiator, an azo-based initiator, peroxide-based initiator, redox-based initiator, and the like may be properly selected according to a polymerization method. At this time, the copolymerization may be performed under presence of thiol compounds such as thioacetic acid and mercaptopropionic acid, or other chain-transfer agents.

As a saponification reaction, alcoholysis, hydrolysis, and the like, which uses a well-known alkali catalyst or acidic catalyst as a saponification catalyst in an organic solvent, may be adopted. In particular, a saponification reaction using a caustic soda catalyst with methanol as a solvent is simple and easy, and thus, most preferable.

In some embodiments, the EVOH used may be a combination of two or more different types of EVOH. For example, the EVOH can be composed of a mixture of two or more types of EVOH that are different in ethylene unit content, with the combination having an ethylene content that is calculated as an average value from a mixed mass ratio. In this case, the difference between two types of EVOH that have different ethylene unit contents is typically about 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 mol % or less.

Similarly, the EVOH can be composed of a mixture of two or more types of EVOH that are different in degree of saponification, with the combination having a degree of saponification that is calculated as an average value from a mixed mass ratio. In this case, the difference in degree of saponification is typically about 7, 6, 5, 4, 3, 2, or 1% or less.

When a crosslinked product obtained from the EVOH is molded into a multilayered structure that is desired, as a multilayered structure, to achieve a balance between thermal moldability and oxygen barrier properties at a high level, the EVOH is preferably used that is obtained by mixing an EVOH having an ethylene unit content of from about 24 mol % to about 34 mol % and a degree of saponification of about 99% or greater, with an EVOH having an ethylene unit content of from about 34 mol % to about 50 mol % and a degree of saponification of about 99% or greater, in a blending mass ratio of about 60/40, 70/30, or 80/20 to about 90/10, or about 60/40 or 70/30 to about 80/20.

The ethylene unit content and the degree of saponification of the EVOH can be determined by conventional methods, such as nuclear magnetic resonance (NMR) analysis, as recognized by one of ordinary skill in the relevant art.

The EVOH may typically have, as a lower limit of a melt flow rate (a measured value at a temperature of 190° C. and a load of 2160 g in accordance with JIS K 7210), a melt flow rate of at least about 0.1, 0.5, 1, 3, 5, 10, 15, 20, 40, 60, 80, 100, or 150 g/10 min or more. On the other hand, the EVOH may typically have, as an upper limit of a melt flow rate, a melt flow rate of about 200, 180, 160, 140, 120, 100, 90, 80, 70, 60, 50, 40, 30, 10, 9, 8, 7, 6, 5, 4, 3, 2, or 1 g/10 min or less. The EVOH having a melt flow rate value in the above ranges may have improved melt kneadability and melt moldability and/or may impart these improved characteristics to a resin composition containing the EVOH.

The EVOH may be modified EVOH, which may include structural units other than the main structural unit. For example, a modified EVOH may have at least one structural unit selected from, for example, structural units (I) and (II) shown below.

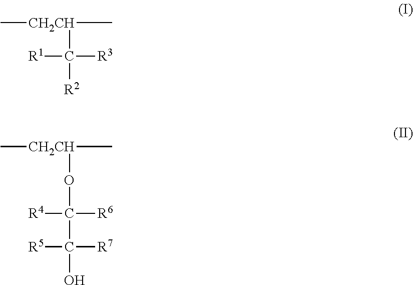

When present, such the structural unit are present at a ratio of at least about 0.5, 1.0, 2.0, 4.0, 6.0, 8.0, 10, 15, 20, or 25 mol % and/or not more than about 1.0, 2.0, 4.0, 6.0, 8.0, 10, 15, 20, 25, or 30 mol % based on the total structural units. Such a modified EVOH may improve flexibility and moldability of a resin or a resin composition, the interlayer adhesion, stretchability and thermoformability of the inner liner.

Each of R¹, R², and R³ in the above formula (I) independently represents a hydrogen atom, an aliphatic hydrocarbon group having at least 1, 2, 3, 4, 5, 6, 7, 8, or 9 carbon atoms and/or not more than 2, 3, 4, 5, 6, 7, 8, 9, or 10 carbon atoms, an alicyclic hydrocarbon group having at least 3, 4, 5, 6, 7, 8, or 9 carbon atoms and/or not more than 4, 5, 6, 7, 8, 9, or 10 carbon atoms, an aromatic hydrocarbon group having at least 6, 7, 8, or 9 carbon atoms and/or not more than 7, 8, 9, or 10 carbon atoms, or a hydroxy group. Also, one pair of R¹, R², and R³ may be combined together (excluding a pair of R¹, R² or R³ in which both of them are hydrogen atoms). Further, the aliphatic hydrocarbon group having, for example, 1 to 10 carbon atoms, the alicyclic hydrocarbon group having, for example, 3 to 10 carbon atoms, or the aromatic hydrocarbon group having, for example, 6 to 10 carbon atoms may have the hydroxy group, a carboxy group or a halogen atom. On the other hand, each of R⁴, R⁵, R⁶, and R⁷ in the above formula (II) independently represents the hydrogen atom, the aliphatic hydrocarbon group having 1 to 10 carbon atoms, the alicyclic hydrocarbon group having 3 to 10 carbon atoms, the aromatic hydrocarbon group having 6 to 10 carbon atoms, or the hydroxy group. R⁴ and R⁵, or R⁶ and R⁷ may be combined together (excluding when both R⁴ and R⁵ or both R⁶ and R⁷ are hydrogen atoms). Also, the aliphatic hydrocarbon group having 1 to 10 carbon atoms, the alicyclic hydrocarbon group having 3 to 10-carbon atoms, or the aromatic hydrocarbon group having 6 to 10 carbon atoms may have the hydroxy group, an alkoxy group, the carboxy group or the halogen atom.

In another example, the following modified EVOH can be used as the EVOH, wherein the modified EVOH copolymer is represented by a following formula (III), contents (mol %) of a, b, and c based on the total monomer units that satisfy following formulae (1) through (3), and a degree of saponification (DS) defined by a following formula (4) and is not less than about 90, 91, 92, 93, 94, or 95 mol %.

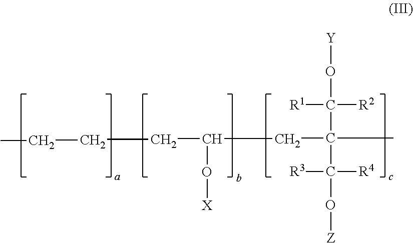

18≤a≤55 (1)

0.01≤c≤20 (2)

[100−(a+c)]×0.9≤b≤[100−(a+c)] (3)

DS=[(Total Number of Moles of Hydrogen Atoms in X,Y, and Z)/(Total Number of Moles of X,Y, and Z)]×100 (4)

In some embodiments, a may be at least 18, 20, 22, 24, 26, 28, 30, 32, 34, 36, 38, 40, 42, 44, 46, 48, 50, or 52 and not more than 20, 22, 24, 26, 28, 30, 32, 34, 36, 38, 40, 42, 44, 46, 48, 50, 52, or 55. In some embodiments, c may be at least 0.01, 0.05, 0.1, 0.2, 0.4, 0.6, 0.8, 1, 2, 4, 6, 8, 10, 12, 14, 16, or 18 and/or not more than 0.05, 0.1, 0.2, 0.4, 0.6, 0.8, 1, 2, 4, 6, 8, 10, 12, 14, 16, 18, or 20.

In the formula (III), each of R′, R², R³, and R⁴ independently denotes a hydrogen atom or an alkyl group having a carbon number of at least 1, 2, 3, 4, 5, 6, 7, 8, or 9 carbon atoms and/or not more than 2, 3, 4, 5, 6, 7, 8, 9, or 10 carbon atoms, and the alkyl group may include a hydroxyl group, an alkoxy group, or a halogen atom. Each of X, Y, and Z independently denotes a hydrogen atom, a formyl group, or an alkanoyl group having a carbon number of from at least 2, 3, 4, 5, 6, 7, 8, or 9 carbon atoms and/or not more than 2, 3, 4, 5, 6, 7, 8, 9, or 10 carbon atoms.

The EVOH may also contain, as a copolymer unit, a small amount of another monomer unit other than the ethylene unit and the vinyl alcohol unit within a range not to inhibit the purpose of the present invention. Examples of such a monomer include α-olefins such as propylene, 1-butene, isobutene, 4-methyl-1-pentene, 1-hexene, and 1-octene; unsaturated carboxylic acids such as itaconic acid, methacrylic acid, acrylic acid, and maleic acid, salts thereof, partial or complete esters thereof, nitriles thereof, amides thereof, and anhydrides thereof; vinylsilane compounds such as vinyltrimethoxysilane, vinyltriethoxysilane, vinyltri(2-methoxyethoxy)silane, and γ-methacryloxypropyltrimethoxysilane; unsaturated sulfonic acids or salts thereof; unsaturated thiols; and vinylpyrrolidones.

The barrier layer may be formed from the EVOH or a resin composition containing the EVOH. In some embodiments, the resin composition containing the EVOH may contain other optional components within a range not to impair the effects of the present invention. Examples of such other components include, for example, a boron compound, an alkali metal salt, a phosphoric acid compound, an oxidizable substance, another polymer, an oxidization accelerator, and another additive.

Addition of a boron compound to the EVOH resin composition may be advantageous in terms of improving melt viscosity of the EVOH and obtaining a homogenous co-extrusion molded product or a co-injection molded product. Examples of suitable boron compounds include boric acids, a boric acid ester, a boric acid salt, and boron hydrides. Specific examples of the boric acids include orthoboric acid (hereinafter, also merely referred to as “boric acid”), metaboric acid and tetraboric acid. Specific examples of the boric acid ester include triethyl borate and trimethyl borate. Specific examples of the boric acid salt include alkali metal salts and alkaline earth metal salts of the above various types of boric acids, and borax. Among these compounds, orthoboric acid is preferred.

When a boron compound is added, the content of the boron compound in the composition is typically at least about 20, 50, 100, 200, 400, 600, 800, 1000, 1200, 1400, 1600, or 1800 ppm, and/or not more than 50, 100, 200, 400, 600, 800, 1000, 1200, 1400, 1500, 1600, 1800, or 2000 ppm, in terms of the boron element equivalent. The content of the boron compound in this range can give EVOH that is produced while torque variation is suppressed during heat melting.

The EVOH resin composition may also contain an alkali metal salt in an amount of at least about 5, 20, 30, 60, 80, 100, 500, 1000, 2000, 3000, or 4000 ppm and/or not more than about 60, 80, 100, 500, 1000, 2000, 3000, 4000, or 5000 ppm, in terms of the alkali metal element equivalent. The resin composition containing an alkali metal salt in the above range can improve the interlayer adhesiveness and the compatibility. An alkali metal is exemplified by, for example, lithium, sodium, and potassium, and the alkali metal salt is exemplified by, for example, an aliphatic carboxylic acid salt, an aromatic carboxylic acid salt, a phosphoric acid salt, and a metal complex of the alkali metal. Examples of the alkali metal salt include sodium acetate, potassium acetate, sodium phosphate, lithium phosphate, sodium stearate, potassium stearate, and sodium salts of ethylene diamine tetraacetic acid. Especially, sodium acetate, potassium acetate, and sodium phosphate are preferred.

The EVOH resin composition may also contain a phosphoric acid compound in an amount of at least about 1, 5, 10, 20, 40, 60, 80, 100, 200, 300, or 400 ppm and/or not more than about 20, 40, 60, 80, 100, 200, 300, 400, or 500 ppm, in terms of the phosphate radical equivalent. Blending the phosphoric acid compound in the above range can improve the thermal stability of the EVOH and suppress, in particular, generation of gel-state granules and coloring during melt molding for a long period of time.

The type of the phosphoric acid compound added to the EVOH resin composition is not particularly limited, and there can be used, for example, various types of acids such as phosphoric acid and phosphorous acid, and salts thereof. The phosphoric acid salt may be any form of a primary phosphoric acid salt, a secondary phosphoric acid salt, and a tertiary phosphoric acid salt. Although the cation species of the phosphoric acid salt is not also particularly limited, an alkali metal or an alkaline earth metal is preferred as the cation species. Especially, the phosphorus compound is preferably added in the form of sodium dihydrogen phosphate, potassium dihydrogen phosphate, disodium hydrogen phosphate or dipotassium hydrogen phosphate.

The EVOH resin composition may also contain various types of other additives within a range not to impair the effects of the present invention. Examples of such other additives include an antioxidant, a plasticizer, a heat stabilizer (melt stabilizer), a photoinitiator, a deodorizer, an ultraviolet ray absorber, an antistatic agent, a lubricant, a colorant, a filler, a drying agent, a bulking agent, a pigment, a dye, a processing aid, a fire retardant, and an anti-fogging agent.

In some embodiments, the barrier layer has a thickness of less than 400, 300, 200, 100, 80, 60, or 40 μm. In some embodiments, a thickness of the EVOH layer, based on a total thickness of the multilayer article, may be at least 1, 2, 3, 4, 5, 6, 7, 8, 9, 10, 11, 12, 13, 14, 15, 16, 17, 18, or 19%, and/or not more than about 7, 8, 9, 10, 11, 12, 13, 14, 15, 16, 17, 18, 19, or 20%. In some embodiments, the thickness of the EVOH layer is less than about 20, or 10%, based on a total thickness of the multilayer article.

### Thermoplastic Resin Layer

In another aspect, the multilayer article of the present disclosure may further include a thermoplastic resin layer. The thermoplastic resin present in the thermoplastic resin layer may not be particularly limited. Examples of suitable thermoplastic resins include a polyamide resin; ethylene-vinyl alcohol copolymer; a polyester resin (e.g., polyethylene terephthalate) that may be elastomeric; ethylene copolymer such as ethylene-α-olefin copolymer; polyurethane that may be elastomeric; acrylic copolymer such as an ethylene-acrylic acid copolymer; polyolefin resins; polyethylenes such as linear low-density polyethylenes, low-density polyethylenes, ultra-low-density polyethylenes, ultra-low-density linear polyethylenes, medium-density polyethylenes, and high-density polyethylenes; polypropylene resins such as polypropylenes, ethylene-propylene (block and random) copolymers, and propylene-α-olefin (C4-20 α-olefin) copolymers; polybutenes; polypentenes; graft polyolefins obtained by graft modification of these polyolefins with an unsaturated carboxylic acid or an ester thereof (e.g., methacrylate modified polyethylene); cyclic polyolefin resins; ionomers; an ethylene-vinyl acetate copolymer; an ethylene-acrylic acid ester copolymer; polyvinyl chloride; polyvinylidene chloride; acrylic resins; polystyrenes; vinyl ester resins; halogenated polyolefins such as chlorinated polyethylenes and chlorinated polypropylenes; and aromatic and aliphatic polyketones.

In another aspect, the thermoplastic resin layer may include at least one resin selected from the group consisting of polyamide, ethylene-vinyl alcohol copolymer, polyethylene terephthalate, ethylene copolymer, polyurethane, acrylic copolymer, and methacrylate modified polyethylene. In some embodiments, the ethylene-vinyl alcohol copolymer may have an ethylene content of 70, 69, 68, 67, 66, 65, 64, 63, 62, 61, 60, 59, 58, 57, 56, 55, 54, 53, 52, 51, or 50 mol % or less, based on a total number of monomer units in the EVOH. In some embodiments, the thermoplastic resin layer may exclude ethylene-vinyl alcohol copolymer.

In another aspect, the thermoplastic resin layer comprises at least one selected from the group consisting of polyamide, ethylene-vinyl alcohol copolymer, and polyethylene terephthalate. In some embodiments, the thermoplastic resin layer comprises polyamide. In some embodiments, the thermoplastic resin layer comprises ethylene-vinyl alcohol copolymer. In some embodiments, the thermoplastic resin layer comprises polyethylene terephthalate.

In another aspect, the thermoplastic resin layer comprises polyurethane or ethylene-vinyl alcohol copolymer with an ethylene content of 50, 49, 48, 47, 46, 45, 44, 43, 42, 41, 40, 39, 38, 37, 36, 35, 34, 33, 32, 31, or 30 mol % or less, based on a total number of monomer units in the EVOH.

In terms of compatibility with polyurea present in the chemical-resistant layer, polyamide, ethylene-vinyl alcohol copolymer, and polyethylene terephthalate may be preferable. In terms of adhesion between polyurea present in the chemical-resistant layer, polyurethane and ethylene-vinyl alcohol copolymer with an ethylene content of 50% or less may be preferable.

For the thermoplastic resin composition, an anti-ultraviolet agent may be preferably added. Examples of the anti-ultraviolet agent include an ultraviolet absorber, a light stabilizer, and a colorant.

The content of the anti-ultraviolet agent in the thermoplastic resin is typically at least about 1, 2, 3, 4, 5, 6, 7, 8, or 9% by weight, and/or not more than about 2, 3, 4, 5, 6, 7, 8, 9, or 10% by weight, based on the total weight of the thermoplastic resin composition. When the content is less than these ranges, the thermoplastic resin composition tends to be degraded by ultraviolet light. When the content is greater than these ranges, the thermoplastic resin composition has poor mechanical strength.

Regarding the melt viscosity of the thermoplastic resin composition, the MFR at 190° C. and a 2160-g load typically has a lower limit of about 0.1, 0.2, 0.5, 1, 5, 10, 30, 40, 60, or 80 g/10 minutes, and typically has an upper limit of about 5, 10, 30, 40, 60, 80, or 100 g/10 minutes. The difference between the MFR of the thermoplastic resin composition and the MFR of the EVOH resin composition may preferably be small. When the melt viscosity of the thermoplastic resin composition is as described above, an excellent multilayer article without layer turbulence may be obtained.

In some embodiments, the thermoplastic resin layer has a thickness of less than 1, 0.9, 0.8, 0.6, 0.5, 0.4, or 0.3 mm.

### Tie Layer

In another aspect, the multilayer article of the present disclosure may further including a tie layer. In some embodiments, the tie layer may be formed from tie resins.

Typical examples of suitable tie resins include carboxyl group-containing modified polyolefin resins obtained by chemically binding an unsaturated carboxylic acid or an anhydride thereof to a polyolefin resin. Specific examples of the tie resin include polyethylenes modified with maleic anhydride, polypropylenes modified with maleic anhydride, a maleic anhydride-modified ethylene-ethyl acrylate copolymer, and a maleic anhydride-graft-modified ethylene-vinyl acetate copolymer. In terms of mechanical strength and molding processability, polyethylenes modified with maleic anhydride and polypropylenes modified with maleic anhydride are preferable, and polyethylenes modified with maleic anhydride are particularly preferable among these.

In another aspect, the tie layer may include an acid-functionalized polymer resin composition.

In another aspect, the acid-functionalized polymer resin composition comprises a carboxyl group-containing modified polyolefin resin obtained by chemically binding an unsaturated carboxylic acid to a polyolefin resin.

In another aspect, the acid-functionalized polymer resin composition comprises a carboxyl group-containing modified polyolefin resin obtained by chemically binding an anhydride of an unsaturated carboxylic acid to a polyolefin resin.

In another aspect, the carboxyl group-containing modified polyolefin resin comprises at least one of a polyethylene modified with maleic anhydride and a polypropylene modified with maleic anhydride.

In another aspect, the acid-functionalized polymer resin composition comprises at least one of a polyethylene modified with maleic anhydride, a polypropylene modified with maleic anhydride, a maleic anhydride-modified ethylene-ethyl acrylate copolymer, and a maleic anhydride-graft-modified ethylene-vinyl acetate copolymer.

In some embodiments, the tie layer may be an adhesive layer for adhesion between barrier layer and the thermoplastic resin layer and may be interposed between these layers.

In another aspect, the tie layer is directly adhered to both of the thermoplastic resin layer and the barrier layer.

Regarding the melt viscosity of the tie resin, the MFR at 190° C. and a 2160-g load typically has a lower limit of about 0.1, 0.2, 0.5, 1, 5, 10, 30, 40, 60, or 80 g/10 minutes, and typically has an upper limit of about 5, 10, 30, 40, 60, 80, or 100 g/10 minutes. The difference between the MFR of the tie resin and the MFR of the EVOH resin composition may preferably be small. When the melt viscosity of the tie resin is as described above, an excellent multilayer article having excellent adhesive strength without any layer turbulence may be obtained.

In some embodiments, the tie layer has a thickness less than 0.2, 0.15 or 0.1 mm.

### Multilayer Article

In another aspect, the multilayer article of the present disclosure may include a thermoplastic resin layer between the chemical-resistant layer and the barrier layer.

In some embodiments, the multilayer article has a thickness of less than 1.9, 1.8, 1.7, 1.6, 1.5, 1.4, 1.3, 1.2 or 1.0 mm.

In another aspect, the thermoplastic layer may be directly adhered to the chemical-resistant layer. In some embodiments, the thermoplastic resin layer may exhibit physical and/or chemical affinity to the chemical-resistant layer. In some embodiments, a surface tension of the thermoplastic layer may be at least 50, 52, 53, 54, 55, 56, 57, or 58 dynes/cm or more than 50, 51, 52, 53, 54, 55, 56, 57, or 58 dynes/cm. The surface tension may be measured by methods known to one of ordinary skill in the art and includes, for example, using fresh Dyne pens, and the method according to ASTM D 5946.

In another aspect, the chemical-resistant layer and the barrier layer are directly adhered to each other. In some embodiments, there are no other layers between the chemical-resistant layer and the barrier layer.

In another aspect, the multilayer article of the present disclosure may further include an adhesive layer comprising polyurea. The polyurea in the adhesive layer may be the same as or different from the polyurea in the chemical-resistant layer.

In another aspect, the multilayer article of the present disclosure may further include a geotextile layer comprising a polyurea-impregnated geotextile between the chemical-resistant layer and the adhesive layer. As used herein, the term “geotextile” refers to any woven or non-woven porous sheet, blanket or mat produced from natural or synthetic fibers. Geotextiles may be made from a variety of synthetic materials such as polypropylene, polyester, nylon, polyvinylchloride and polyethylene or from natural fibers such as jute or cotton. They may be woven using monofilament yarns or slit film, or non-woven needled, heat set, or resin bonded fabrics. Geotextiles may be available commercially from numerous manufacturers in the United States. As those skilled in the art are aware, geotextiles may be used to line earthen surfaces. Such liners may have secondary uses in lining roofs, ponds, reservoirs, landfills, and underground storage tanks, canals or ditches.

The geotextile layer may include one or more geotextiles.

The polyurea-impregnated geotextile may be formed by methods known to those of ordinary skill in art. For example, polyurea may be applied to a geotextile via spraying as disclosed in U.S. Pat. No. 9,056,714, incorporated by reference in its entirety herein. The amount of polyurea applied to the geotextile may not be particularly limited. For example, the amount applied per square meter may be from 0.2 kg to 20 kg, or from 0.5 kg to 5 kg. The amount of polyurea applied may be in an amount between any combination of these values, inclusive of the recited values. In some embodiments, the basis weight (g/m²) of the polyurea-impregnated geomembrane may be about or less than 2500, 2400, 2300, 2200, 2100, 2000, 1900, 1800, 1700, 1600, 1500 or 1400 g/m² as calculated from the density of the resins. In some embodiments, the basis weight of the thermoplastic resin layer may be less than 1400, 1300, 1200, 1100, 1000, 9000 or 800 g/m². In some embodiments, the basis weight for the tie layer may be less than 200, 180, 160, 140, 120, or 100 g/m². In some embodiments, the basis weight for the barrier layer may be less than 300, 280, 260, 240, 220, 200 or 180 g/m². In some embodiments, the basis weight of the geotextile may be less than 600, 580, 560, 540, 520, 500, 480, 460, or 440 g/m².

In another aspect, the adhesive layer may be located between the geotextile layer and the barrier layer.

In another aspect, said geotextile layer may be directly adhered to the chemical-resistant layer and the adhesive layer.

In another aspect, the adhesive layer may be directly adhered to the barrier layer.

In another aspect, the multilayer article of the present disclosure may further include a thermoplastic resin layer, where the thermoplastic resin layer may be between the adhesive layer and the barrier layer. The thermoplastic resin layer may include at least one thermoplastic resin as described above. The thermoplastic resin in this thermoplastic resin layer may be the same as or different from the thermoplastic resin used in other thermoplastic resin layers.

In another aspect, the thermoplastic resin layer may be directly adhered to the adhesive layer.

In another aspect, the chemical-resistant layer may include a polyurea-impregnated geotextile. In some embodiments, the polyurea-impregnated geotextile may the outermost layer of the multilayer article.

In another aspect, the multilayer article of the present disclosure may further include an adhesive layer including polyurea between the chemical-resistant layer and the barrier layer.

In another aspect, said adhesive layer may be directly adhered to the chemical-resistant layer.

In another aspect, said adhesive layer may be directly adhered to the barrier layer.

In another aspect, the multilayer article of the present disclosure may further include a thermoplastic resin layer, where the thermoplastic resin layer is between the adhesive layer and the barrier layer. The thermoplastic resin layer may include at least one thermoplastic resin as described above. The thermoplastic resin in this thermoplastic resin layer may be the same as or different from the thermoplastic resin used in other thermoplastic resin layers.

In another aspect, the thermoplastic resin layer may be directly adhered to the adhesive layer.

In another aspect, the multilayer article of the present disclosure may further include another thermoplastic resin layer. The thermoplastic resin layer may include at least one thermoplastic resin as described above. The thermoplastic resin in this thermoplastic resin layer may be the same as or different from the thermoplastic resin used in other thermoplastic resin layers.

In another aspect, said another thermoplastic resin layer may not be located between the barrier layer and the chemical-resistant layer.

In another aspect, said another thermoplastic resin layer may be an outermost layer of the multilayer article.

In another aspect, the thermoplastic resin layer may include at least one resin selected from the group consisting of polyamide, ethylene-vinyl alcohol copolymer, polyethylene terephthalate, ethylene copolymer, polyurethane, acrylic copolymer, and methacrylate modified polyethylene. In some embodiments, the ethylene-vinyl alcohol copolymer may have an ethylene content of 70% or less.

In another aspect, the thermoplastic resin layer may include at least one selected from the group consisting of polyamide, ethylene-vinyl alcohol copolymer, and polyethylene terephthalate.

In another aspect, the thermoplastic resin layer comprises polyurethane or ethylene-vinyl alcohol copolymer with an ethylene content of 50% or less.

In another aspect, each of the chemical-resistant layer, the adhesive layer, and the geotextile layer may not be adhered to a layer comprising at least one of polyethylene, polypropylene, vinyl acetate, ethylene-vinyl acetate, and polyolefin.

### Plurality of Multilayer Articles

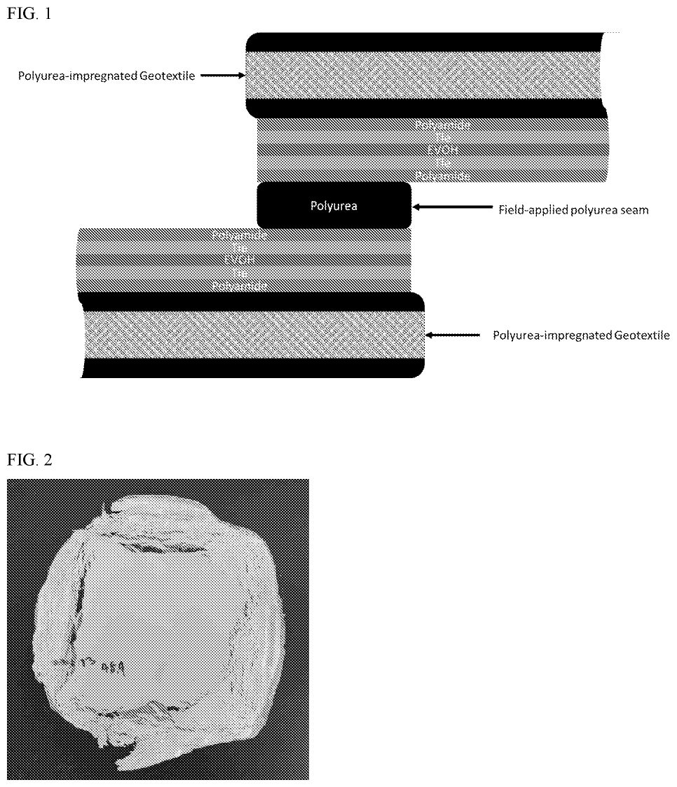

In another aspect, an article includes (i) the multilayer article of the present disclosure, (ii) another multilayer article including: another chemical-resistant layer including a polyurea, where said another chemical-resistant layer is not an adhesive layer between two layers, and another barrier layer including an ethylene-vinyl alcohol copolymer, and (iii) a seam layer between the multilayer article and said another multilayer article. FIG. 1 shows an example embodiment of the article. In some embodiments, for covering a larger area, two or more multilayer articles may be desired and may be arranged adjacent to each other with edges overlapped to form a seam, for example, as shown in FIG. 1. The multilayer articles may be adhesively joined by introducing a seam resin between the overlapping edges to form the seam layer.

In another aspect, the seam layer may include polyurea. In some embodiments, the polyurea in the seam layer may be the same as or different from the polyurea in the chemical-resistant layer.

In another aspect, the seam layer may be directly adhered to layers, each of which may independently include at least one resin selected from the group consisting of polyamide, ethylene-vinyl alcohol copolymer, polyethylene terephthalate, ethylene copolymer, polyurethane, acrylic copolymer, and methacrylate modified polyethylene. In some embodiments, the ethylene-vinyl alcohol copolymer may have an ethylene content of 70, 69, 68, 67, 66, 65, 64, 63, 62, 61, 60, 59, 58, 57, 56, 55, 54, 53, 52, 51, or 50 mol % or less, based on a total number of monomer units in the EVOH.

In another aspect, the seam layer may be directly adhered to layers, each of which may independently include at least one selected from the group consisting of polyamide, ethylene-vinyl alcohol copolymer, and polyethylene terephthalate.

In another aspect, the seam layer may be directly adhered to layers, each of which may independently include polyurethane or ethylene-vinyl alcohol copolymer with an ethylene content of 50, 49, 48, 47, 46, 45, 44, 43, 42, 41, 40, 39, 38, 37, 36, 35, 34, 33, 32, 31, or 30 mol % or less, based on a total number of monomer units in the EVOH.

In another aspect, the seaming layer may include a foam body.

In another aspect, the article of the present disclosure may include a structure:

PU1/X1/(T1/X2/T2)n/X3/PU2/X4/(T3/X5/T4)n/X6/PU3

Where PU1 may be a first polyurea-impregnated geotextile layer, PU2 may be a seam layer comprising polyurea, PU3 may be a second polyurea-impregnated geotextile layer, each of X1, X2, X3, X4, X5 and X6 may independently be a thermoplastic resin layer or a barrier layer, where at least one may be a barrier layer, each of X1, X3, X4 and X6 may independently include at least one resin selected from the group consisting of polyamide, ethylene-vinyl alcohol copolymer, polyethylene terephthalate, ethylene copolymer, polyurethane, acrylic copolymer, and methacrylate modified polyethylene, each of T1, T2, T3 and T4 may independently include a tie resin composition, and, n is a whole number from 1 to 12. In some embodiments, the ethylene-vinyl alcohol copolymer may have an ethylene content of 70% or less.

In another aspect, each of X1, X3, X4 and X6 may independently include at least one selected from the group consisting of polyamide, ethylene-vinyl alcohol copolymer, and polyethylene terephthalate.

In another aspect, each of X1, X3, X4 and X6 may independently include polyurethane or ethylene-vinyl alcohol copolymer with an ethylene content of 50% or less.

In some embodiments, other functional layers may be incorporated into the multilayer article or article to provide additional desired properties such as heat sealability, scuff resistance, flexibility, and toughness. Such other layers are generally known to those of ordinary skill in the relevant art.

In some embodiments, the substructure X1/(T1/X2/T2)n/X3 may be produced by methods known to those of ordinary skill in the art and may include nanolayer extrusion.

### Methods of Use or Manufacturing Thereof

In another aspect, the multilayer article of the present disclosure or the article of the present disclosure is a geomembrane.

In another aspect, the multilayer article of the present disclosure or the article of the present disclosure is used for environmental protection of air, soil, and/or water.

In another aspect, the multilayer article of the present disclosure or the article of the present disclosure is used for maintaining the quality of air, soil, and/or water.

In another aspect, the multilayer article of the present disclosure or the article of the present disclosure is used for protecting the quality of air, soil, and/or water. In some embodiments, the multilayer article or article may be deployed and installed as secondary containment liners for chemical tank farms and other high risk environmental contaminant spill containment applications.

In another aspect, the multilayer article of the present disclosure or the article of the present disclosure is used as a liner for secondary containment of chemicals in a tank farm and/or a chemical processing unit.

In another aspect, the multilayer article of the present disclosure or the article of the present disclosure is used as a liner for capping of a brownfield site.

In another aspect, the multilayer article of the present disclosure or the article of the present disclosure is used as a liner for a under-slab vapor intrusion membrane.

In another aspect, the multilayer article of the present disclosure or the article of the present disclosure is used as a liner or a cover for a geotechnical application.

In another aspect, the geotechnical application may include at least one of refuse landfill, sewage and/or waste residue treatment plants, and containment of residuals from oil and/or gas fields.

In another aspect, a use of the multilayer article of the present disclosure or the article of the present disclosure for environmental protection of air, soil, and/or water.

In another aspect, a use of the multilayer article of the present disclosure or the article of the present disclosure for maintaining the quality of air, soil, and/or water.

In another aspect, a use of the multilayer article of the present disclosure or the article of the present disclosure for protecting the quality of air, soil, and/or water.

In another aspect, a use of the multilayer article of the present disclosure or the article of the present disclosure for a liner for secondary containment of chemicals in a tank farm and/or a chemical processing unit.

In another aspect, a use of the multilayer article of the present disclosure or the article of the present disclosure for a liner for capping of a brownfield site.

In another aspect, a use of the multilayer article of the present disclosure or the article of the present disclosure for a liner for a under-slab vapor intrusion membrane.

In another aspect, a use of the multilayer article of the present disclosure or the article of the present disclosure for a liner or a cover for a geotechnical application.

In another aspect, the geotechnical application comprises at least one of refuse landfill, sewage and/or waste residue treatment plants, and containment of residuals from oil and/or gas fields.

In another aspect, the multilayer article of the present disclosure or the article of the present disclosure may exclude a citric acid-modified polyvinyl amine layer.

In another aspect, a process for preparing the multilayer article of the present disclosure or the article of the present disclosure includes applying the chemical-resistant layer to the barrier layer. In some embodiments, the barrier layer may be formed by a process including melting the EVOH resin composition and then molding the resultant melt (a melt molding process) to form the barrier layer.

In another aspect, the application of the chemical-resistant layer may include mixing precursors of the polyurea to form the polyurea and applying the resulting mixture to the barrier layer.

In another aspect, the application of the chemical resistant layer may exclude thermally pressing the chemical-resistant layer and the barrier layer.

In some embodiments where at least one of the thermoplastic resin layer and the tie layer may be present, the process may include melt molding the EVOH resin composition, thermoplastic resin composition, and/or the tie resin composition to form a multilayer structure, and applying the chemical-resistant layer to the resultant multilayer structure. Further examples of the process may include melt extrusion of the EVOH resin composition, thermoplastic resin composition, and/or the tie resin composition to form each layer; co-extruding all layers; disposing the layers in a side-by-side relationship to form the multilayer structure; and applying the chemical-resistant layer to the resultant multilayer structure.

In other embodiments where the seam layer may be present between the multilayer article and said another multilayer article, the process may include applying the seam layer to at least a portion of one of the edges of the multilayer article and contacting the applied seam layer with at least a portion of one of the edges of the another multilayer article. In some embodiments, application of the seam layer may include spraying the seam resin onto at least a portion of one of the edges of the multilayer article to form the seam layer.

### EXAMPLES

The present invention is more specifically described by way of examples. The scope of the present invention, however, is not limited to these examples.

### Comparative Example 1

As a screening experiment, a monolayer polyolefin elastomer, epoxy modified SBS (Epofriend AT501), was cast for a thermal pressing trial. The cast film was thermally pressed to a polyurea geomembrane in a heated press where the stationary platen and the moveable platen were set to 149° C. Specifically, the cast film was placed adjacent to the polyurea geomembrane and sandwiched between teflon-coated foils to prevent sticking of the film/geomembrane composite to the platens. Pressure was applied using a hydraulic press for 60 seconds at 10000 psi, followed by 30 seconds at 15000 psi, and finally 30 seconds at 18000 psi.

### Comparative Example 2

The process described in Comparative Example 1 was carried out using MAh-SEBS (Hybrar H7318M) as the polyolefin elastomer.

### Comparative Example 3

The process described in Comparative Example 1 was carried out using MAh-alpha olefin (Tafmer MH7010) as the polyolefin elastomer.

### Comparative Example 4

The process described in Comparative Example 1 was carried out using MAh-alpha olefin (Tafmer MP0610) as the polyolefin elastomer.

### Comparative Example 5

The process described in Comparative Example 1 was carried out using MAh-CO-EBA (Elvaloy HP441) as the polyolefin elastomer.

### Results

In all of the comparative examples, no significant adhesion between the cast film and polyurea geomembrane could be achieved. Instead, the polyurea geomembrane deteriorated to a crumbled state, for example, see FIG. 2.

### Example 1 (Comparative Example)

A liquid polyurea was formed by pouring Roboliner B Side (TCS HM, B-side) into Roboliner A Side (TCS HM, A-side) in 1:1 ratio. TCS HM (B-side) includes, based on a total weight of TCS HM B-side, 27-45 wt % of 4,4′-methylenebis[N-(1-methylpropyl)-benzenamine, 18.5-31 wt % of N,N′-(methylenedi-4,1-cyclohexanediyl)bis-1,1′,4,4′-tetraethyl aspartic acid ester, 17.2-29 wt % of poly(propyleneglycol)diamine, 6-24 wt % of a cyclic propylene ester of carbonic acid, 0.12-2.2 wt % of aliphatic carboxylic ester, and 0.02-0.29% of odorless mineral spirits. TCS HM (A-side) includes, based on a total weight of TCS HM A-side, 36-60 wt % of polyglycol 15, a polymer of glycerin and ethylene oxide, 24-41 wt % of MDI (monomer), and 7.8-31 wt % of 4,4′-diphenylmethane diisocyanate. The mixture was mixed for two to three minutes to allow the two components to react. Subsequently, the viscous mixture was brushed/rolled onto one of the PCR layers of various co-extruded films such as PCR/tie/EVOH/tie/PCR where PCR was a polyurea-compatible resin, such as polyethylene (PE), and tie was a tie resin. PE was not treated with a corona treatment before the application of polyurea. The resulting thickness of the applied polyurea ranged from 0.200 to 0.800 inches.

### Example 2

The process described in Example 1 was carried out using polypropylene (PP) as the polyurea-compatible resin.

### Example 3

The process described in Example 1 was carried out using an α-olefin copolymer, Tafmer™, as the polyurea-compatible resin.

### Example 4

The process described in Example 1 was carried out using a modified ethylene copolymer, Elvaloy™, as the polyurea-compatible resin.

### Example 5 (Comparative Example)

The process described in Example 1 was carried out using ethylene-vinyl acetate polymer (EVA) as the polyurea-compatible resin.

### Example 6

The process described in Example 1 was carried out using thermoplastic polyurethane (TPU) as the polyurea-compatible resin.

### Example 7

The process described in Example 1 was carried out using EVOH as the polyurea-compatible resin. The ethylene unit content in and saponification degree of EVOH was measured using 1H-NMR measurement (JNM-GX-500, JEOL Ltd., Tokyo Japan) using DMSO-d6 as a solvent. The discharging rate (g/10 minutes) of an EVOH sample was measured by a melt flow indexer (MP1200, Tinius Olsen TMC, Horsham, Pennsylvania USA) under conditions of a temperature at 190° C. and with a load of 2160 g.

### Example 8

The process described in Example 1 was carried out using polyamide as the polyurea-compatible resin.

### Example 9

The process described in Example 1 was carried out using polyethylene terephthalate (PET) as the polyurea-compatible resin.

### Conditions for Preparing Co-Extruded Film

The co-extruded EVOH films for Examples 1-9 was prepared under the following conditions, followed by trimming into a film.

### Layer Structure

5-material-5-layer (PCR/tie/EVOH/tie/PCR)

PCR: As listed in each example.

Tie: As listed in Table 1.

EVOH: As listed in Table 1.

### Conditions for Co-Extrusion

Apparatus: a 7-material-7-layer blown film extruder (Brampton Engineering, Brampton, Ontario Canada)

### Extruder

Extruder A: 45-mmφ single screw extruder (L/D=24), Extruder B: 30-mmφ single screw extruder (L/D=24), Extruder C: 30-mmφ single screw extruder (L/D=24), Extruder D: 30-mmφ single screw extruder (L/D=20), Extruder E: 30-mmφ single screw extruder (L/D=24), Extruder F: 30-mmφ single screw extruder (L/D=24), Extruder G: 45-mmφ single screw extruder (L/D=24)

Extruder B was used for the PCR layer, Extruder C was used for tie layer, Extruder D was used for EVOH layer, Extruder E was used for tie layer and Extruder F was used for PCR layer.

Extruder A and G were not used for making the five-layer co-extruded film.

### Temperature Setting (° C.)

Extruder B and F: C1/C2/C3/A=180/190/205/205

Extruder C and E: C1/C2/C3/A=190/225/215/220

Extruder D: C1/C2/C3/A=180/210/215/220

Die: 150 mm, temperature set at 220° C.

The examples described herein used the following materials listed in Table 1.

TABLE 1

| | | Thickness | | Density | | Basis weight |
|---|---|---|---|---|---|---|
| Material | Code | (μm) | (m) | (g/cm³) | (g/m²) | (g/m²) |
| PCR (PET) | Selenis Bondz GG174 | 1000 | 0.001 | 1.27 | 1270000 | 1270 |
| PCR (PA6) | BASF B36 | 1000 | 0.001 | 1.13 | 1130000 | 1130 |
| PCR (EVOH-24) | Kuraray | 1000 | 0.001 | 1.22 | 1220000 | 1220 |
| PCR (EVOH-48) | Kuraray | 1000 | 0.001 | 1.12 | 1120000 | 1120 |
| PCR (EVA)¹ | Ultrathene UE624000 | | | | | |
| Tie (MAh-LLDPE) | Admer NF498A | 200 | 0.0002 | 0.92 | 920000 | 184 |
| Tie (MAh-PP) | Admer QF551A | 200 | 0.0002 | 0.9 | 900000 | 180 |
| Tie (MAh-elastomer) | Admer SF600 | 200 | 0.0002 | 0.86 | 860000 | 172 |
| EVOH (24 mol % et.) | Kuraray | 200 | 0.0002 | 1.22 | 1220000 | 244 |
| EVOH (48 mol % et.) | Kuraray | 200 | 0.0002 | 1.12 | 1120000 | 224 |
| PP Nonwoven Geotextile² | Terrafix 420R | | | | | 212 |
| PP Woven Geotextile³ | Terrafix 400W | | | | | 190 |
| PP Nonwoven Geotextile⁴ | US Fabrics 380NW | | | | | 524.4 |
| PP Woven Geotextile | US Fabrics 315 | | | | | 203.4 |
| PP Nonwoven Geotextile | US Fabrics PG1 | 280 | 127120 | 258.33 | 215.7 | 589 |
| PP Nonwoven Geotextile | US Fabrics PG2 | 268 | 121672 | 346 | 288.9 | 421 |
| PP Nonwoven Geotextile | US Fabrics PG3 | 235 | 106690 | 346 | 288.9 | 369 |
| Low IV PET for geotextile | Eastman F61HC | 0 | | 1.34 | 0 | 0 |

¹This material has a vinyl acetate content of 18%.
²This material has a weight of 280 lbs (127,120 g) and an area of 258.33 yd² (215.7 m²).
³This material has a weight of 268 lbs (121,672 g) and an area of 346 yd² (288.9 m²).
⁴This material has a weight of 235 lbs (106,690 g) and an area of 346 yd² (288.9 m²).

### Evaluation of Examples 1-9

The adhesion of the polyurea and the polyurea-compatible resin for Examples 1-9 was tested using a hand pull test. The results are as follows:

| PCR Substrate | Example | Ranking |
|---|---|---|
| TPU | 6 | A |
| EVOH | 7 | A |
| PET | 9 | B |
| PA | 8 | B |
| EVA | 5 | C |
| PE | 1 | C |

A = good adhesion
B = moderate adhesion
C = no adhesion

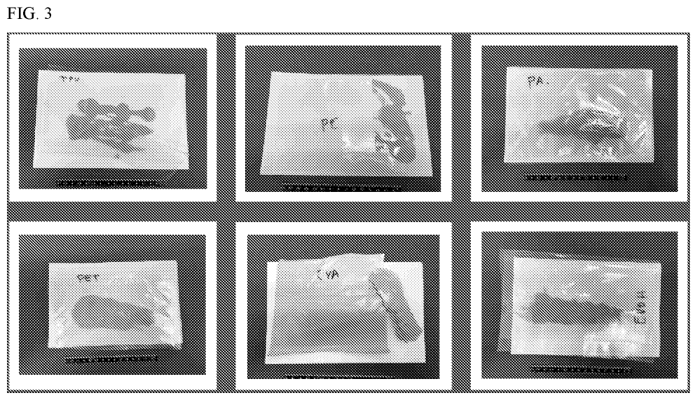

No adhesion between polyurea and the polyurea-compatible resin was observed in Examples 1-5. FIG. 3 (second column) also shows that polyurea (yellow) does not adhere to PE (clear film) and EVA (beige film). Adhesion between polyurea and the polyurea-compatible resin was observed in Examples 6-9. See FIG. 3, images on the first and third columns. In Examples 7-9, the surface tension for the polyurea-compatible resin was more than 50 dynes/cm, as measured with fresh Dyne pens. Among these examples, the adhesion between polyurea and EVOH was the strongest.

### Example 10

A liquid polyurea was formed by mixing equal volumes of Roboliner B Side (TCS HM, B-side) and Roboliner A Side or equal volumes of TCS 380-CL A and TCS 380-CL B, all of which are manufactured by MatLor, LLC. TCS 380-CL A contained 50-65 wt % of a MDI prepolymer, 10-20 wt % of 4,4′-diphenylmethane diisocyanate, 10-20 wt % of diphenylmethane diisocyanate mixed isomers, and 10% or less of 4-methyl-1,3-dioxolan-2-one. TCS 380-CL B contained 40-60 wt % of polyoxypropylenediamine, 10-20 wt % of diethylmethylbenzenediamine, 10-20 wt % of glyceryl poly(oxypropylene) triamine, and 10-15 wt % of N,N′-dialkylamino-diphenylmethane. The precursors to polyurea was allowed to react and applied prior to curing onto various co-extruded films such as PCR/tie/EVOH/tie/PCR where PCR was a polyurea-compatible resin, such as polyamide (PA); BASF Ultramid B36 and tie was a tie resin as disclosed herein: Admer NF498A. The polyurea was allowed to cure before further tests are conducted.

### Example 11

The process described in Example 10 will be carried out using polyethylene (PE) as the polyurea-compatible resin.

### Example 12

The process described in Example 10 will be carried out using polyethylene terephthalate (PET) as the polyurea-compatible resin.

### Example 13

The process described in Example 10 will be carried out using polyurethane as the polyurea-compatible resin.

### Oxygen Transmission Rate (OTR) Measurement

Using two sheets of multilayer film, the oxygen transmission rate was measured according to the method described in JIS K7126 (isobaric method) under 20° C.-65% RH conditions using the MOCON OX-TRAN 2/20 model manufactured by AMETEK, and the average value was obtained. In Example 10, the OTR was below 0.005 cc/m²·day·atm (detection limit). In Examples 11-13, the OTR will be at least below 0.01 cc/m²·day·atm.

### Adhesion Strength

After polyurea is cured, the multilayer article will be cut into 15 mm wide sections. The interface between polyurea and PCR will be tested by attempting to peel the polyurea off. In Example 10, the polyurea was difficult to peel off and result in breakage of the multilayer article. In Examples 11-13, the polyurea will be difficult to peel off and result in breakage of the multilayer article. Or if polyurea can be peeled off, adhesion strength will be measured by using a tensile tester (Model 4466, Instron, Norwood, Massachusetts USA) at tensile speed of 250 mm/min, and the adhesion strength will be over 200 g/15 mm.

### Permeation Coefficient

Stainless steel diffusion cells with source and receptor compartments will be used for the aqueous diffusion test. The multilayer article will be secured between the source and receptor compartments. The source and receptor will be sampled until equilibrium is reached. Samples will be taken frequently at early stages of testing, and a decreased frequency at later stages, when changes in concentration will be smaller. Cells will be agitated by magnetic stirrers and maintained at 22° C. Once equilibrium is reached, a mass balance will be performed to check that there is no significant leakage from the cells during the tests. Samples will be tested using a dilute aqueous BTEX (Benzene/Toluene/Ethyl Benzene/Xylene) source solution with initial concentrations of approximately 20-40 μg/g. Deionized water will be placed into the cell receptor compartment.

Source and receptor diffusion samples will be analyzed by purge and trap gas chromatography/mass spectrometry (P&T)-GC/MS using selective ion monitoring (SIM) using a Hewlett Packard 5890 GC with a P&T unit and 5972 mass selective detector. The VOC P&T method will be based on USDA method 8260B.

The diffusion from the source to the receptor will be plotted normalized with respect to the initial source concentration (C) for the specific compound and the samples with time. The diffusion tests will be characterized by a decrease in source concentration coupled with an increase in receptor concentration until both values eventually reached equilibrium. The vapor barriers will reach equilibrium within approximately 0-14 days. The diffusion coefficients (D) and partition coefficients (S) will be inferred by fitting the results of the theoretical model to the observed change in concentrations with time. Permeation coefficients (P) will be calculated by formula (III) below.

P=S*D (III)

In Examples 10-13, P will be in a range of from 0.001*10⁻¹⁰ to 0.06*10⁻¹⁰ m²/s.

### Tensile Modulus

In accordance with ISO527-3, tensile modulus of the multilayer article from Example 10 was evaluated. The sample was subjected to humidity conditioning under conditions of 23° C./50% RH. Then, the sample was cut into a strip having a width of 15 mm and a length of 12 cm. Tensile modulus was measured by tensile tester (Model 4466, Instron, Norwood, Massachusetts USA) in MD direction at chuck distance of 50 mm and a tensile speed of 5 mm/minute. Tensile modulus will be calculated from the stress-strain curve. In Example 10, the tensile modulus was 114 MPa for Machine Direction (MD) and 133 MPa for Transverse Direction (TD). In Example 11-13, the tensile modulus will be at least 100 MPa for both of MD and TD.

### Toughness

The toughness of multilayer article from Examples 10-13 will be measured by calculating the area under the stress strain curve from a tensile test.

### Bleed Out

The samples will cover a 100 mL metal container filled with BTEX (Benzene/Toluene/Ethyl Benzene/Xylene=25/25/25/25 wt %) solvent. The chemical-resistant layer of the samples will face outside. The container will be placed in oven at 80° C./1 month. After that, sample surface will be analyzed by Fourier transform infrared spectroscopy (FT-IR) (Nicolet 6700, Thermo Electron Corporation, Madison, Wisconsin USA) with ATR (attenuated total reflection) mode. The presence of bleed-out of the plasticizer will be checked from the FT-IR chart. In Examples 10-13, no bleed-out will be observed.

The test results from Examples 10-13 will show that a multilayer article in accordance with the present invention is suitable for geomembrane applications in terms of a desirable combination of barrier properties for BTEX, toughness, flexibility, and long-term use.

1. A multilayer article comprising:
a chemical-resistant layer comprising a polyurea, wherein the chemical-resistant layer is not an adhesive layer between two layers, and
a barrier layer comprising an ethylene-vinyl alcohol copolymer.

2. The multilayer article according to claim 1, wherein the chemical-resistant layer is an outermost layer of the multilayer article.

3. The multilayer article according to claim 1, further comprising a thermoplastic resin layer, wherein the thermoplastic resin layer is between the chemical-resistant layer and the barrier layer.

4. The multilayer article according to claim 3, wherein the thermoplastic resin layer comprises at least one resin selected from the group consisting of polyamide, ethylene-vinyl alcohol copolymer with an ethylene content of 70 mol % or less, polyethylene terephthalate, ethylene copolymer, polyurethane, acrylic copolymer, and methacrylate modified polyethylene.

5. The multilayer article according to claim 4, further comprising a tie layer directly adhered to both of the thermoplastic resin layer and the barrier layer.

6. The multilayer article according to claim 5, wherein the tie layer comprises an acid-functionalized polymer resin composition.

7. The multilayer article according to claim 1, wherein the chemical-resistant layer consists of polyurea.

8. The multilayer article according to claim 3, wherein the thermoplastic resin layer is directly adhered to the chemical-resistant layer.

9. The multilayer article according to claim 1, wherein the chemical-resistant layer and the barrier layer are directly adhered to each other.

10. The multilayer article according to claim 1, further comprising:
an adhesive layer comprising polyurea, and
a geotextile layer comprising a polyurea-impregnated geotextile between the chemical-resistant layer and the adhesive layer.

11. The multilayer article according to claim 10, wherein the adhesive layer is located between the geotextile layer and the barrier layer.

12. The multilayer article according to claim 11, wherein said geotextile layer is directly adhered to the chemical-resistant layer and the adhesive layer.

13. The multilayer article according to claim 1, wherein the chemical-resistant layer comprises a polyurea-impregnated geotextile.

14. An article comprising:
the multilayer article of claim 1;
another multilayer article comprising another chemical-resistant layer comprising a polyurea, wherein said another chemical-resistant layer is not an adhesive layer between two layers, and another barrier layer comprising an ethylene-vinyl alcohol copolymer; and
a seam layer between the multilayer article and said another multilayer article.

15. The article according to claim 14, wherein the seam layer comprises polyurea.

16. The article according to claim 14, wherein the seam layer is directly adhered to layers, each of which independently comprising at least one resin selected from the group consisting of polyamide, ethylene-vinyl alcohol copolymer with an ethylene content of 70 mol % or less, polyethylene terephthalate, ethylene copolymer, polyurethane, acrylic copolymer, and methacrylate modified polyethylene.

17. The article according to claim 14, comprising a structure:
PU1/X1/(T1/X2/T2)n/X3/PU2/X4/(T3/X5/T4)n/X6/PU3
wherein
PU1 is a first polyurea-impregnated geotextile layer;
PU2 is the seam layer comprising polyurea;
PU3 is a second polyurea-impregnated geotextile layer;
each of X1, X2, X3, X4, X5 and X6 is independently a thermoplastic resin layer or a barrier layer, wherein at least one is a barrier layer;
each of X1, X3, X4 and X6 independently comprises at least one resin selected from the group consisting of polyamide, ethylene-vinyl alcohol copolymer, polyethylene terephthalate, ethylene copolymer with an ethylene content of 70 mol % or less, polyurethane, acrylic copolymer, and methacrylate modified polyethylene;
each of T1, T2, T3 and T4 independently comprises a tie resin composition; and
n is a whole number from 1 to 12.

18. The article according to claim 17, wherein each of X1, X3, X4 and X6 independently comprises at least one selected from the group consisting of polyurethane or ethylene-vinyl alcohol copolymer with an ethylene content of 50 mol % or less.

19. The multilayer article according to claim 1, which is a geomembrane.

20. The article according to claim 14, which is a geomembrane.
